(19) United States
(12) Patent Application Publication
(10) Pub. No.: US 2009/0327434 A1
(43) Pub. Date: Dec. 31, 2009

(54) Method, Apparatus, and Computer Program Product for Anonymous Polling

(75) Inventor: Franklin Reynolds, Bedford, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/164,453

(22) Filed: Jun. 30, 2008

(51) Int. Cl. G06F 15/16

(52) U.S. Cl. 709/206

(57) ABSTRACT

An apparatus for anonymous polling may include a processor. The processor may be configured to receive an input message and identify whether the input message includes a request or a response to the request and, if the input message includes the request, the processor may be further configured to identify a source of the input message. The processor may also be configured to provide for transmission of an output message. In this regard, based on the whether the input message includes a request or a response, and based on the source of the input message, the apparatus may operate as a referral agent, a responder, or a forwarding agent. Associated methods and computer program products may also be provided.

### TECHNICAL FIELD

Embodiments of the present invention relate generally to information sharing and, more particularly, relate to an apparatus, method and a computer program product for anonymous sharing of information.

### BACKGROUND

Gathering information about consumers, such as habits, preferences, demographic information, other personal information and the like has become an important aspect of marketing and advertising. This information can often be aggregated and analyzed to identify trends. Often statistical operations are performed on the information to reveal the trends. The trends may be indicative of business opportunities or strategies to avoid. Businesses and the like may use these trends in decision making, such as, for example, to determine what age group of consumers to target in an advertising campaign.

While the information about consumers has proven to be quite useful, gathering this information can often be problematic. Privacy concerns are one main hurdle that may be considered when gathering information about consumers, particularly personal information about a consumer. In this regard, some consumers may be quite comfortable sharing personal information to be used for market analyses. Others may be willing to share their personal information, such as, for example, their habits, but may prefer to have their identity concealed. For example, a consumer may be comfortable revealing information regarding where the consumer shops for groceries, but the consumer may not be comfortable with the information being stored in association with the consumer's name, address, or other information that may be used for identifying the consumer. Examples of other information that may be used to identify a consumer may include an electronic address, such as an internet protocol (IP) address or a media access control (MAC) address associated with a communications device used by the consumer. In this regard, a user maybe identified by the communications device that the consumer is using to provide the information. Devices that may reveal such information may include computers, mobile telephones, personal organizers, and the like.

As such, a mechanism for gathering information about individuals that does not also reveal the identity of the individual would be desirable. In particular, it would desirable to implement mechanisms that allow users to provide information, such as habits, via communications devices in a manner that maintains the user's anonymity.

### BRIEF SUMMARY

A method, apparatus, and computer program product are therefore described that maintain anonymity. In this regard, exemplary embodiments of the present invention may conceal the identity of a responder to a request from the requester. Exemplary embodiments of the present invention may maintain anonymity of a responder by routing requests and responses to requests through other entities so as to conceal the identity of the actual responder from the requester. To facilitate concealing the identity of responders, anonymity groups may be utilized. In this regard, in some exemplary embodiments, anonymity groups may be collections of nodes where the users of the nodes have offered to share a particular type of information. The anonymity group may be limited to reveal only the type of information that describes or defines the anonymity group.

As such, some exemplary embodiments may receive an input message and identify whether the input message includes a request or a response to the request. Some exemplary embodiments may further identify a source of the input message if the input message includes a request. Additionally, some exemplary embodiments may provide for transmission of an output message. In this regard, the output message may take various forms and be transmitted to various entities depending on, for example, the content of the incoming message and the source of the incoming message. When the input message includes a request and the source of the input message is identified as a request provider, the output message may include the request and the output message may be transmitted to a member of an anonymity group. When the input message includes a request and the source of the input message is identified as a member of an anonymity group, the output message may include a response and the output message may be transmitted to a member of the anonymity group. Also, when the input message includes a response, the output message may include the response. Based on the foregoing, a request and a response may be routed thorough members of an anonymity group to conceal the identity of the responder.

In one exemplary embodiment, a method for anonymous polling is described. The exemplary method may include receiving an input message and identifying whether the input message includes a request or a response to the request. If the input message includes the request, the exemplary method may further include identifying a source of the input message. The exemplary method may also include providing for transmission of an output message. In this regard, providing for transmission of the output message may comprise the output message including the request and the output message being transmitted to a member of an anonymity group, when the input message includes the request and the source of the input message is identified as a request provider. Providing for transmission of the output message may also comprise the output message including the response and the output message being transmitted to a member of the anonymity group, when the input message includes the request and the source of the input message is identified as a member of an anonymity group. Additionally, providing for transmission of the output message may comprise the output message including the response, when the input message includes the response.

In another exemplary embodiment, an apparatus for anonymous polling is described. The apparatus may include a processor. The processor may be configured to receive an input message and identify whether the input message includes a request or a response to the request. In this regard, if the input message includes the request, the processor may be further configured to identify a source of the input message. The processor may also be configured to provide for transmission of an output message. The output message may include the request and the output message may be transmitted to a member of an anonymity group, when the input message includes the request and the source of the input message is identified as a request provider. Further, the output message may include the response and the output message may be transmitted to a member of the anonymity group, when the input message includes the request and the source of the input message is identified as a member of an anonymity group. Also, the output message may include the response, when the input message includes the response.

In another exemplary embodiment, a computer program product for publishing content is described. The computer program product may include at least one computer-readable storage medium having computer-readable program code portions stored therein. The computer-readable program code portions may include a first program code portion, a second program code portion, and a third program code portion. The first program code portion may be configured to receive an input message and the second program code portion may be configured to identify whether the input message includes a request or a response to the request. In this regard, if the input message includes the request, the second program code portion may be configured to also identify a source of the input message. The third program code portion may be configured to provide for transmission of an output message. The output message may include the request and the output message may be transmitted to a member of an anonymity group, when the input message includes the request and the source of the input message is identified as a request provider. Further, the output message may include the response and the output message may be transmitted to a member of the anonymity group, when the input message includes the request and the source of the input message is identified as a member of an anonymity group. Also, the output message may include the response, when the input message includes the response.

In yet another exemplary embodiment, an apparatus for anonymous polling is described. The exemplary apparatus may include means for receiving an input message, and means for identifying whether the input message includes a request or a response to the request and, if the input message includes the request, means further identifying a source of the input message. The exemplary apparatus may also include means for providing for transmission of an output message. The output message may include the request and the output message may be transmitted to a member of an anonymity group, when the input message includes the request and the source of the input message is identified as a request provider. Further, the output message may include the response and the output message may be transmitted to a member of the anonymity group, when the input message includes the request and the source of the input message is identified as a member of an anonymity group. Also, the output message may include the response, when the input message includes the response.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a user terminal according to an exemplary embodiment of the present invention;

FIGS. 2a and 2b illustrate systems for anonymous polling according to exemplary embodiments of the present invention;

FIG. 3 illustrates a request and response routing for anonymous polling according to exemplary embodiments of the present invention;

FIG. 4 illustrates a block diagram showing an apparatus for anonymous polling with associated network connectivity according to an exemplary embodiment of the present invention;

FIG. 5 illustrates a flowchart for anonymous polling according to exemplary embodiments of the present invention;

FIGS. 6a and 6b illustrate message formats according to exemplary embodiments of the present invention; and

FIG. 7 illustrates a flowchart for anonymous polling according to exemplary embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

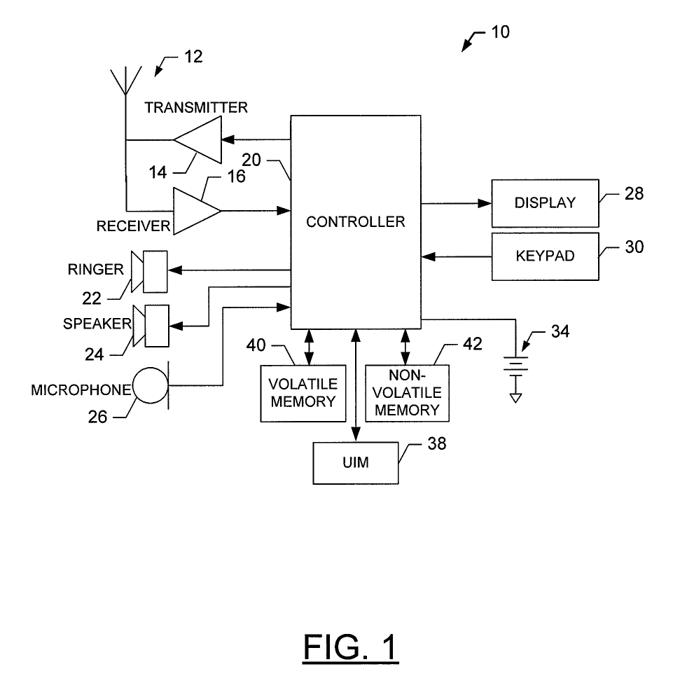

FIG. 1 illustrates a block diagram of a user terminal 10 that could benefit from, and may be an exemplary apparatus that incorporates, embodiments of the present invention. In some exemplary embodiments, user terminal 10 may be a mobile terminal. It should be understood, however, that a mobile telephone as illustrated and hereinafter described is merely illustrative of one type of user terminal that would benefit from embodiments of the present invention and, therefore, should not be taken to limit the scope of embodiments of the present invention. While several embodiments of the user terminal 10 are illustrated and will be hereinafter described for purposes of example, other types of mobile and fixed terminals, such as portable digital assistants (PDAs), mobile communications devices, pagers, televisions, gaming devices, mobile computers, laptop computers, personal computers, still/video cameras, video recorders, audio/video players, radios, positioning devices (e.g., Global Positioning Devices (GPDs)), sensor devices (e.g., temperature sensors, physiological sensors) or any combination of the aforementioned, and other types of voice and text communications systems, can readily employ embodiments of the present invention.

In addition, while several embodiments of the method of the present invention may be performed or used by a user terminal 10, the method may be employed by other than a mobile terminal. Moreover, the apparatus and method of embodiments of the present invention will be primarily described in conjunction with mobile communications applications. It should be understood, however, that the apparatus and method of embodiments of the present invention can be utilized in conjunction with a variety of other applications, both in the mobile communications industries and outside of the mobile communications industries.

The user terminal 10 may include an antenna 12 (or multiple antennas) in operable communication with a transmitter 14 and a receiver 16 or transceiver (or in communication with one or more transmitters, receivers, and/or transceivers). The user terminal 10 may further include an apparatus, such as a controller 20 or other processing element that provides signals to and receives signals from the transmitter 14 and receiver 16, respectively. The signals may include or be representative of signaling information in accordance with the air interface standard of the applicable cellular system, and also user speech, received data and/or user generated data. In this regard, the user terminal 10 may be capable of operating with one or more air interface standards, communication protocols, modulation types, and/or access types. By way of illustration, the user terminal 10 may be capable of operating in accordance with any of a number of first, second, third and/or fourth-generation communication protocols or the like. For example, the user terminal 10 may be capable of operating in accordance with second-generation (2 G) wireless communication protocols IS-136 (time division multiple access (TDMA)), GSM (global system for mobile communication), and IS-95 (code division multiple access (CDMA)), or with third-generation (3 G) wireless communication protocols, such as Universal Mobile Telecommunications System (UMTS), CDMA2000, wideband CDMA (WCDMA) and time division-synchronous CDMA (TD-SCDMA), with 3.9 generation (3.9 G) wireless communication protocols, such as Evolved Universal Terrestrial Radio Access Network (E-UTRAN), with fourth-generation (4 G) wireless communication protocols or the like. As an alternative (or additionally), the user terminal 10 may be capable of operating in accordance with non-cellular communication mechanisms. For example, the user terminal 10 may be capable of communication in a wireless local area network (WLAN), or other communication networks. Further, the user terminal 10 can communicate in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. Further, the user terminal 10 may receive IP (internet protocol) datacasting via broadcasting, multicasting, or unicasting over one or more digital audio/radio/video/television broadcasting protocols such as Digital Audio Broadcasting (DAB), Digital Video Broadcasting (DVB), Digital Video Broadcasting—Handheld (DVB-H), MediaFLO, or Digital Multimedia Broadcasting (DMB).

It is understood that the apparatus, such as the controller 20, may include circuitry desirable for implementing audio and logic functions of the user terminal 10. For example, the controller 20 may be comprised of a digital signal processor device, a microprocessor device, and various analog to digital converters, digital to analog converters, and other support circuits. Control and signal processing functions of the user terminal 10 may be allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the user terminal 10 to transmit and receive Web content, such as location-based content and/or other web page content, according to a Wireless Application Protocol (WAP), Hypertext Transfer Protocol (HTTP) and/or the like, for example.

The user terminal 10 may also comprise a user interface that may include an output device such as a conventional earphone or speaker 24, a ringer 22, a microphone 26, a display 28, and/or a user input interface, all of which may be coupled to the controller 20. The user input interface, which allows the user terminal 10 to receive data, may include any of a number of devices allowing the user terminal 10 to receive data, such as a keypad 30, a touch display (not shown) or other input device. In embodiments including the keypad 30, the keypad 30 may include the conventional numeric (0-9) and related keys (#, *), and/or other hard and soft keys used for operating the user terminal 10. Alternatively, the keypad 30 may include a conventional QWERTY keypad arrangement. The keypad 30 may also include various soft keys with associated functions. In addition, or alternatively, the user terminal 10 may include an interface device such as a joystick or other user input interface. The user terminal 10 may further include a battery 34, such as a vibrating battery pack, for powering various circuits that are required to operate the user terminal 10, as well as optionally providing mechanical vibration as a detectable output.

The user terminal 10 may further include a user identity module (UIM) 38. The UIM 38 may be a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 may store information elements related to a mobile subscriber. In addition to the UIM 38, the user terminal 10 may be equipped with memory. For example, the user terminal 10 may include volatile memory 40, such as volatile Random Access Memory (RAM) including a cache area for the temporary storage of data. The user terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the user terminal 10 to implement the functions of the user terminal 10. For example, the memories can include an identifier, such as an international mobile equipment identification (IMEI) code, capable of uniquely identifying the user terminal 10. Furthermore, the memories may store instructions for determining cell id information. Specifically, the memories may store an application program for execution by the controller 20, which may determine an identity of the current cell, i.e., cell id identity or cell id information, with which the user terminal 10 is in communication.

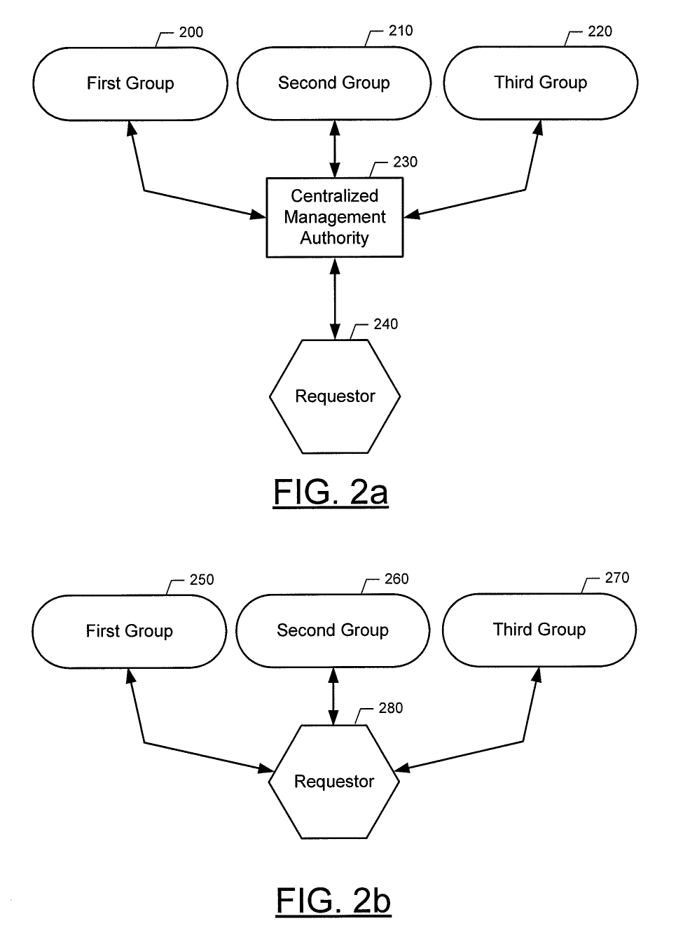

Referring now to FIGS. 2a and 2b, exemplary systems for anonymous polling are described. The system of FIG. 2a, describing one embodiment of the invention, includes various user groups, such as anonymity groups, including a first group 200, a second group 210, and a third group 220. The system of FIG. 2a also includes a centralized management authority 230 and a requester 240.

According to exemplary embodiments of the present invention, requester 240 may be any type of device for storing, retrieving, computing, transmitting, and/or receiving data or information. In this regard and in some exemplary embodiments, the requestor 240 may be an application server or other network device, such as an access point or router, configured to provide requests of information to various nodes. Additionally, the requester 240 may be a user terminal 10, or a service provider. The requests may target any type of information describing, for example, the habits, preferences, or experiences of a user associated with a node (e.g. the type of music the user prefers, the audio or video programs that the user prefers, shopping locations the user prefers, political preferences of the user, the traffic status at the user's current location, audio/video play lists, accessed Internet pages, Internet cookies, received/accessed/clicked/read advertisements, etc.), personal information about the user associated with the node (e.g., gender, age, marital status, family size, income, user profile, etc.), information that may be gathered from or in a memory device associated with the node (e.g., location information, communications information, contact information, usage statistics, usage logs, communication logs, or other information captured or stored by the node), or any other type of information. According to various embodiments, a node may be a mobile or fixed terminal (e.g., user terminal 10), a computer, a server, a software application, an application accessed using a browser or other front-end application, or the like. In this regard, in some embodiments, a request may be a query of the user of the node (i.e., input may be required by the user) in a polling mode implementation, or a request may be a query of information that may be stored on the node in a data collection mode implementation (i.e., input need not be required by the user).

The centralized management authority 230 or other service provider may also be any type of device for storing, retrieving, computing, transmitting, and/or receiving data or information. In some exemplary embodiments, the centralized management authority 230 may be an application server, other network device, or user terminal 10 configured to receive a request from the requester 240 and forward the request to one or more selected user groups, such as anonymity groups (e.g., first group 200, second group 210, or third group 220.) The centralized management authority 230 may act as a buffer between the requestor and the anonymity groups and identifiers of the groups in general. In various embodiments, the centralized management authority 230 may provide limited access control between the requester and the anonymity groups. In this regard, the centralized management authority 230 may have access to addresses (e.g., IP addresses, MAC addresses, phone numbers, unique identifiers, or the like) of some or all of the members of the anonymity groups. However, in some exemplary embodiments, the centralized management authority 230 need not have access to personal information about the users associated with the nodes within the anonymity group. The addresses may be used to forward a request originating from the requester 240 to members of an anonymity group. The centralized management authority 230 may be configured to randomly or pseudo-randomly select members of the anonymity group to receive the request. In this regard, the centralized management authority 230 may also consider load balancing when selecting members of the anonymity group to receive the request.

The centralized management authority 230 may also be configured to receive a response from a member of an anonymity group and forward the response to the requester 240. In some exemplary embodiments, the centralized management authority 230 may also be configured to remove any information from the response that may be used to identify a responder, such as, for example, the sender's identity information. In some exemplary embodiments, the centralized management authority 230 may be configured to summarize and/or aggregate a plurality of received responses and provide the summarized and/or aggregated responses to the requester 240, so as to further isolate the responses from the responders. In this regard, homomorphic encryption protocols may be utilized to condition the responses.

A user group, such as an anonymity group, may be a collection of nodes (i.e., group members) that have one or more common characteristics. In this regard, in some exemplary embodiments, particular anonymity groups may be defined that offer to respond to requests directed to a specific topic. For example, a first anonymity group may be defined for political preference requests, while a second anonymity group may be defined for location requests. Additionally, the groups may be already defined or existing user groups, such as interest groups, service subscribers (e.g. music service), or the like. Accordingly, in some embodiments, a political preference request may be sent to the first anonymity group, but not the second anonymity group. As such, in some exemplary embodiments, anonymity groups may be associated with only one type of information request. In this manner, differing types of information requests may be directed to different anonymity groups associated with the request type (e.g., political views, music preferences, shopping preferences, location information, etc.). Alternatively, the information request or survey to one group may comprise multiple questions covering political views, music preferences, shopping preferences, location information, or the like.

In some exemplary embodiments, the anonymity group may be predefined based on a common characteristic of the group members. In some exemplary embodiments, the common characteristic may be a type of information that the members of the group have chose to share with the requester. For example, an anonymity group may be defined of nodes having associated users that have offered to share information regarding the music that the users prefer. A user's offer to share a particular type of information may be indicated by the user during a registration process as described below. In embodiments where the anonymity group is predefined, requests provided by the requestor 240 may specify the predetermined anonymity group that may receive the request. Further, in some exemplary embodiments, members of the predefined anonymity group may announce their membership in the group to the other members and/or share addresses with the other members of the group.

In some exemplary embodiments, a number of desired responses may also be provided with the request, and as such, in some situations only a subset of the members of an anonymity group may receive a request. As such, in embodiments where the anonymity group is predefined, the requester 240 may be have access to information describing the anonymity groups available for receiving a request, but the requestor 240 need not have access to the identity, or information that may be used to determine the identity, of nodes and associated users within the anonymity group. Predefined anonymity groups may be registered with the centralized management authority 230, the requester 240, or a search engine on, for example, the Internet. Predefined anonymity groups registered with a search engine may be located for use by any requester.

Additionally, or alternatively, in some exemplary embodiments, one request may result in one reply. However, in other exemplary embodiments, a request may include a representation of the number of desired replies. Accordingly, in these exemplary embodiments, one request may result in multiple replies. In this manner, the number of requests may be minimized.

In some exemplary embodiments, the anonymity group may be dynamically defined based on criteria provided in association with a request. For example, a request may be generated to determine the political views of a population. In response to the request, an anonymity group may be defined such that all of the members of the anonymity group have offered to provide responses regarding political views. A user's offer to share a particular type of information (e.g., political views) may be indicated by the user during a registration process as described below. In some exemplary embodiments, the number of desired responses to the request may also be provided and defining the anonymity group may also be based upon the number of desired responses. In some exemplary embodiments, the centralized management authority 230 may dynamically define the anonymity group based upon information provided in association with the request. Further, in some exemplary embodiments, members of the dynamically defined anonymity group may announce their membership in the group to the other members and/or share addresses with the other members of the group.

In some exemplary embodiments, a user registration may be required for a user and/or a node associated with a user to be a prospective member of an anonymity group. During registration, a user may provide information, such as profile information (e.g., name, address, phone, email, age, occupation, or any other information) that may be stored on a node associated with the user or may be stored on a remote memory device such as a server. Further, in the registration process a user may choose to become a member of one or more anonymity groups. In this regard, a user may select the anonymity groups based on the information that members of the anonymity group may make available for responding to a request. For example, if a user desires to share the user's location with a requester, the user may choose to be a member of a location anonymity group. In this example, global positioning, triangulation, or other location determining techniques implemented by a node associated with a user may be used to provide the location of the user. In some embodiments, a user may modify (i.e., add, change, delete, etc.) the user's membership in various anonymity groups. Selecting and modifying anonymity group choices may be executed by clicking on the group via a user interface of the node. Additionally, in some exemplary embodiments, the registration process may also involve downloading an application to the node that may be utilized in maintain anonymity as described below.

Members of a user group, such as an anonymity group, may share identification information, such as address information and/or group identification, amongst the group members in various manners. For example, in some exemplary embodiments, members of the groups may be included in a contact list or phonebook that may be shared amongst the members of the group. The contact list, phonebook, and/or one or more contacts may be shared amongst the members of the group by the members themselves, (i.e., one member may transfer the group identification information to another member), or a service provider may manage the contact list or phonebook for the group (i.e., receive, store, and transmit identification information and/or one or more contacts) and make the contact list or phonebook accessible to members of the group. In this regard, the service provider may also send updates to the contact list, phonebook, or one or more contacts, possibly in advance of sending a request. Further, in some embodiments, a service provider may manage the identification information and upon request form a group member, provide identification information of another member for utilization. In some exemplary embodiments, group member identification information and/or group member's contact information may be included in a communication between group members, such as, for example, in the request, and the identification information may also be shared in this manner.

With respect to the operation of the system of FIG. 2a, the requester 240 may provide a request to the central management authority 230. The request may indicate the predefined anonymity group that the request is directed to, or the request may indicate criteria that the centralized management authority 230 may use to dynamically define and/or select the target anonymity group. The central management authority 230 may then forward the request to members of the target anonymity group and receive responses to the request from members of the anonymity group such that the responding member nodes are anonymous, as further described below. The centralized management authority 230 may then forward the anonymous responses to the requester 240.

FIG. 2b illustrates an alternative system for anonymous polling according to various embodiments of the present invention. The system of FIG. 2b may include various anonymity groups such as a first group 250, a second group 260, and a third group 270. The system of FIG. 2b may also include a requester 280. Notably, the system of FIG. 2a does not include a centralized management authority, such as centralized management authority 230. However, in some exemplary embodiments, requester 280 may be configured to perform some or all the functionality of the centralized management authority 230 and the requester 240.

Since the system of FIG. 2b does not include a centralized management authority, the requester 280 may have access to some or all of the addresses of members of the anonymity groups. As such, the requester 280 may forward a request directly to members of a predefined anonymity group. Anonymous responses may be returned to the requester 280 as described below. Further, the requester 280 may also have access to information about the nodes and the users of the nodes such that the requester 280 may dynamically define anonymity groups based on the information.

The anonymity groups in the exemplary embodiments of FIGS. 2a and 2b may be multiple groups containing a large number of nodes. In this regard, the use of multiple large groups, where each group includes distinct common characteristics, may create difficulty for data mining mechanisms to determine information about any specific user. This may come as a result of the distinct information being gathered from differing groups, rather than from the same group. As a result, a linkage between various gathered information may not be determined because the members of each group may be different.

Additionally, to maintain anonymity of the responders to the requests originating from the requesters, various exemplary embodiments of the present invention may implement a routing scheme for requests and responses within the anonymity group. The routing scheme may implement a level of indirection (e.g., possibly through the use of buffer devices) between the requester and the responder. In various exemplary embodiments, the requests and responses may be included in a message. As the messages are routed via intermediate entities, information about the final destination or the original source may be replaced in the message or otherwise removed. As such, by inserting intermediate entities between a requester and responder, information about the responder may be concealed for the requester.

In this regard, an incoming request to the anonymity group may be received by one or more nodes within the group. The node receiving the request from an entity outside the anonymity group may be defined as a referral agent. The referral agent may redirect or forward the request to another node within the anonymity group. A node that receives a request from another member of the anonymity group (e.g., the referral agent) may act as a responder. The responder may generate a response to the request and forward the response to another member of the anonymity group. A node that receives a response, for example, from a responder, may act as a forwarding agent. The forwarding agent may be configured to forward or redirect the response to the request provider or to another entity outside the anonymity group that may receive the response.

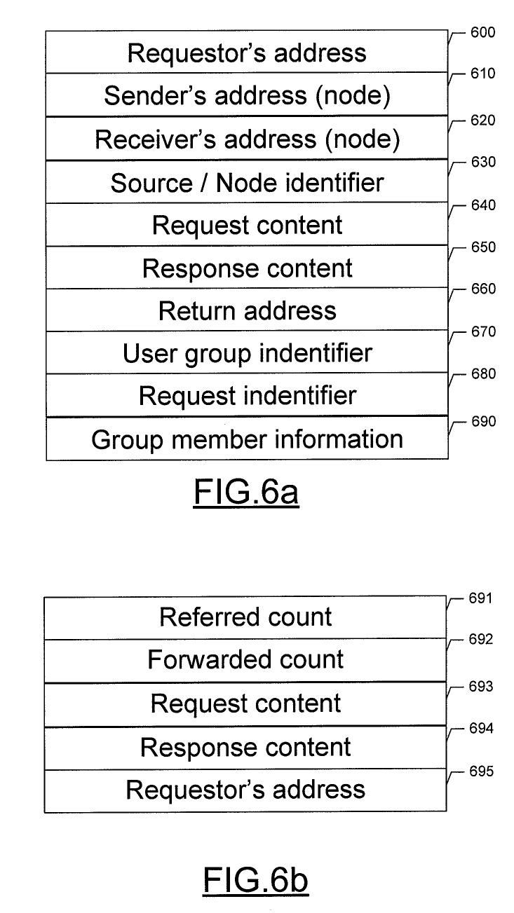

Communications (e.g., requests and responses) between members of a user group, such as an anonymity group may utilize any message format. FIGS. 6a and 6b depict exemplary message formats that may be utilized in some exemplary embodiments of the present invention. With respect to the exemplary message formats of FIGS. 6a and 6b, each field or portion of the message formats may be optional, and fields or portions of each of the message formats may be combined with either message format. The exemplary message format may include a requestor's address 600. The requestor's address may be a permanent field including the address of the requester, such as, for example, requesters 240 or 280.

The exemplary message format may also include a sender's address 610. The sender's address may be the address of the sending node. As such, the sender's address may be the address of a group member and the sender's address 610 may change in each transmission of a communication.

The exemplary message format may also include a receiver's address 620. The receiver's address may be the address of the receiving node. As such, the receiver's address may be the address of a group member and the receiver's address 620 may change in each transmission of a communication. The source of the receiver's address 620 may be, for example, the message itself or the contact list or phonebook in the sender's device.

The exemplary message format may include a source/node identifier 630. The source/node identifier 630 may identify the role of the sending or receiving entity (e.g., requester, referral agent, responder, forwarding agent, or the like). As with any portion or field of the exemplary message format, the source/node identifier 630 may be an optional field.

The exemplary message format may also include request content 640. The request content 640 may be a representation of the request. The exemplary message format may also include response content 650. The response content 650 may be a representation of the response that was inputted by the responder node.

The exemplary message format may also include a return address 660. The return address 660 may be an address of an entity that is to receive the response to the request. In exemplary embodiments where the requester will also receive the response, the return address 660 may be the same as the requestor's address 600.

The exemplary message format may further include a user group identifier 670. The user group identifier 670 may be a representation of the user group that the message is directed to. As with any portion or field of the exemplary message format, the user group identifier 670 may be an optional field.

The exemplary message format may further include group member information 690. The group member information 690 may include identification information for one or more members of the user group. The group member information 690 may include contact information (e.g., addresses) of the members of the user group that may be used to send the message to the other members/nodes. As with any portion or field of the exemplary message format, the group member information 690 may be an optional field.

FIG. 6b illustrates another exemplary message format that may be used in accordance with embodiments of the present invention. The exemplary message format may include a referred count 691, a forwarded count 692, request content 693, response content 694, and a requestor address 695.

In this regard, the referred count 691 may indicate the number of referrals the message has experienced. For example, if the message has been referred five times, the number five, or a representation thereof, may appear in the referred count field. The referred count may be incremented each time the message (i.e., the request) is referred. Further, in some exemplary embodiments, a threshold referred count may be included in the message format in the referred count field or elsewhere in a message format. The threshold referred count may be compared to the referred count to determine whether further referrals are to be undertaken. In some exemplary embodiments, when the referred count equals the threshold, further referrals need not be performed.

The forwarded count 692 may indicate the number of forwards the message has experienced. For example, if the message has been forwarded five times, the number five may appear in the forwarded count field. The forwarded count may be incremented each time the message (i.e., the response) is forwarded. Further, in some exemplary embodiments, a threshold forwarded count may be included in the message format in the forwarded count field or elsewhere in a message format. The threshold forwarded count may be compared to the forwarded count to determine whether further forwards are to be undertaken. In some exemplary embodiments, when the forwarded count equals the threshold, further forwards need not be performed.

The request content 693 may be embodied in the same manner as the request content 640. Similarly, the response content 694 may be embodied in the same manner as the response content 650. Also, the requestor's address 695 may be embodied in the same manner as the requestor's address 600.

With regard to the interactions between the nodes, any node within the anonymity group may operate as a referral agent, a responder, or a forwarding agent, and have one or more of these roles at the same time for the same request or for different requests. Further, each node within the anonymity group may have access to addresses for the other members of the anonymity group to facilitate the routing of the requests and responses. For example, in some embodiments, a peer-to-peer protocol may be used to propagate group membership additions and deletions. In some embodiments, for example, the group member information 690 may be included in the message itself. Additionally, or alternatively, in some embodiments, the address may be selected automatically or manually from the phonebook/contact list stored in, for example, the user terminal 10 when the phonebook/contact list may include an indication as to which groups the various contacts/users belong.

With respect to the different roles a node may implement, a node that is a referral agent may be a node within the anonymity group that receives the request from an entity outside the anonymity group, such as a requestor or a centralized management authority. The entity outside of the anonymity group may have access to some or all of the addresses of the members of the anonymity group, for example, via user registration to a group or a service. As such, the entity outside the anonymity group may use the addresses to send a request to the anonymity group by sending the request to a referral agent.

Upon receipt of the request from the entity outside the anonymity group, the referral agent may redirect or forward the request to another member of the anonymity group (i.e., the responder). The redirection or forwarding of the request may facilitate concealing the identity of a responder. In some exemplary embodiments, the referral agent may redirect or forward the request to one or more members of the anonymity group. Since each member of an anonymity group may have access to the addresses of any other member of the anonymity group, the request may be addressed to any member of the anonymity group. In this regard, the referral agent may be configured to select a member of the anonymity group to receive the request and, as a result, become a responder.

According to various embodiments, selection of a node to be the responder may be based on any criteria or no criteria. In some exemplary embodiments, the selection of a responder node may be based on a preference of the user of the referral agent node. Where the preference of the user of the referral agent node is implemented as a means for selecting the responder node, it is expected that the user's preference may change over time and different nodes may be selected with respect to various requests. As such, the user associated with the referral agent node may pick a node to be the responder based on no static criteria. In some exemplary embodiments, a responder node device may be automatically selected or selected through user assistance by the referral agent node randomly or pseudo-randomly. Because the selection of the responder may be unpredictable, the identity (e.g., the address) of the responder may be concealed from any entity outside of the anonymity group that has provided the request.

Upon receipt of the request from another member or node of the anonymity group, the responder may generate a response to the request. In this regard, the responder node may receive information input such as, for example, one or more answers and/or permission for response, by a user via, for example, a user interface, in response to the request, or the responder node may generate a response automatically based on information available to the responder node. In some exemplary embodiments, the responder node may ignore the request and no response may be generated or sent. Further, in some exemplary embodiments, the user may have a veto authority to prevent a response from being provided, particularly in situations where a node may be configured to automatically provide a response. Upon generating a response, the responder node may send the response to a forwarding agent. In some exemplary embodiments, upon generating the response, the responder may be configured to encrypt the response. Encryption may be performed with the use of a public key associated with the request provider. In this regard, the response information need not be accessible to the other members of the anonymity group, due to the encryption of the response.

According to various embodiments, selection of a node to be the forwarding agent may be based on any criteria or no criteria. In some exemplary embodiments, the selection of a forwarding agent node may be based on a preference of the user of the responder node. Where the preference of the user of the responder node is implemented as a means for selecting the forwarding agent node, it is expected that the user's preference may change over time and different nodes may be selected with respect to various responses. As such, the user associated with the responder node may pick a node to be the forwarding agent based on no static criteria. In some exemplary embodiments, a forwarding agent node may be automatically selected by the responder node randomly or pseudo-randomly.

In some exemplary embodiments, the responder may send the response to another member of the anonymity group that is a responder to the same request (i.e., a previous responder). The previous responder may interpret the response or a message including the response and determine that the previous responder was also a responder to a common request. If the previous responder determines that it was also a responder to the common request, then the previous responder may be configured to redirect or forward the response to a forwarding agent. In this manner, members of the anonymity group may be unable to identify which responder (i.e., the responder or the previous responder) is associated with the response.

Upon receipt of a response, the forwarding agent node may redirect or forward the response to an entity outside of the anonymity group (e.g., the request provider 300). In some exemplary embodiments, a forwarding agent node may determine whether the sender of the response is a member of the anonymity group, and determine its role as a forwarding agent node based on whether the response was received from a member of the anonymity group. Because the selection of the forwarding agent may be unpredictable, the identity (e.g., the address) of the responder may not be predictably associated with the forwarding agent. As such, the identity (e.g., the address) of the responder node may be concealed from any entity outside of the anonymity group that receives the response. In this regard, in some exemplary embodiments, the forwarding agent may also be configured to remove any information from the response that may be used to identify the responder.

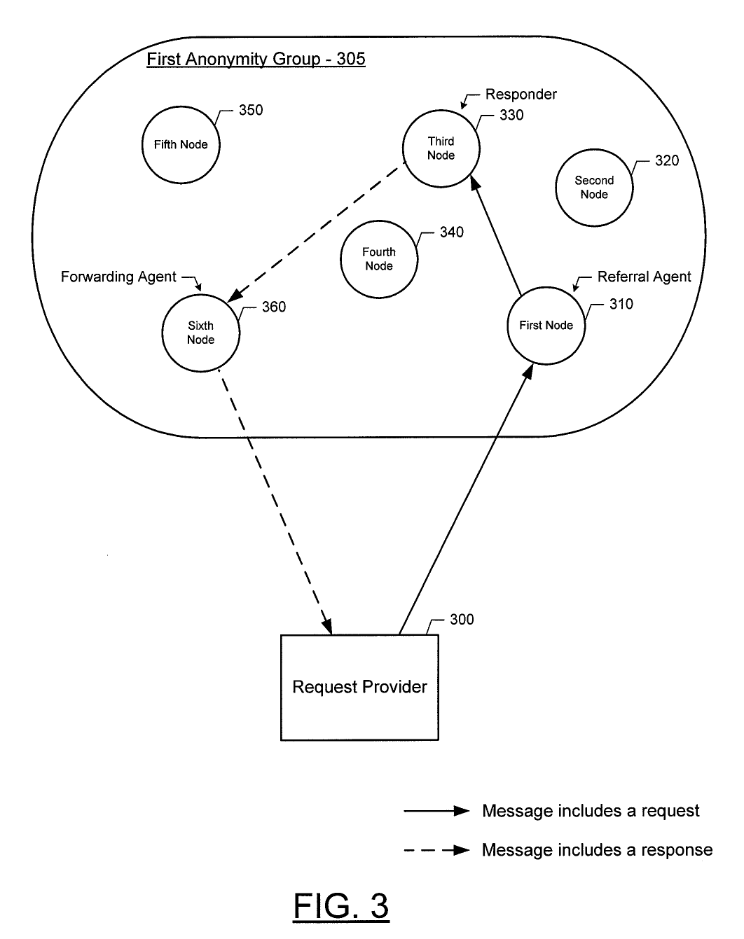

FIG. 3 illustrates an exemplary request and response routing scheme as described above for anonymous polling according to exemplary embodiments of the present invention. The system of FIG. 3 includes a request provider 300, a first user group 305 including one or more nodes, such as a first node 310, a second node 320, a third node 330, a fourth node 340, a fifth node 350, and a sixth node 360. In some exemplary embodiments, the node, such as, for example, node 310 may be a plurality of nodes.

The request provider 300 may be configured to send a request to one or more members of an anonymity group. In some exemplary embodiments, the request provider 300 may be a device that originates requests, such as the requesters 240 or 280. In other exemplary embodiments, the request provider 300 may be a device that forwards requests, such as the centralized management authority 230. The request provider 300 may target the first anonymity group 305 as a predefined group or the request provider 300 may use criteria to dynamically define the first anonymity group 305.

The nodes (i.e., the first node 310, the second node 320, etc.) may be members of the first anonymity group 305. In this regard, as described above, the group may be predefined or dynamically defined. Each of the members of the anonymity group may have access to, or otherwise know, the addresses of the other members of the anonymity group.

In this exemplary request and response routing scheme, the request provider 300 may have access to or otherwise know an address for the first node 310. As such, the request provider 300 may send a message including a request to the first node 310. By receiving the message including a request from an outside entity (i.e., an entity that is a non-member of the anonymity group) the first node 310 may recognize its role as a referral agent node. As such, the first node 310 may redirect or forward a message including a request to another member of the anonymity group. In this exemplary request and response routing scheme, the first node 310, acting as the referral agent node, selects the third node 330 to be the responder node. As such, the first node 310 sends a message including the request to the third node 330.

Having received a request from a member of the anonymity group, the third node 330 may recognize its role as a responder node. As such, the third node may generate a response and send a message including the response to another member of the anonymity group (i.e., the forwarding agent node). In this exemplary request and response routing scheme, the third node 330, acting as the responder node, selects the sixth node 360 to be the forwarding agent node. As such, the third node 330 may send a message including the response to the sixth node 360.

Having received a response, the sixth node 360 may recognize its role as a forwarding agent node. As such, the sixth node may redirect or forward a message including the response to an outside entity, such as to the request provider 300, the requesters 240 or 280, the centralized management authority 230, or to some other entity identified in the message (i.e., an address of this other entity may follow through the process in the message). In this exemplary request and response routing, the sixth node 360, acting as the forwarding agent node redirects or forwards a message including the response to the request provider 300.

For illustration purposes the request and response routing scheme of FIG. 3 is described with respect to a request for a single response. However, it is contemplated that any number of requests and responses and any or multiple roles of nodes may be implemented in various exemplary embodiments of the present invention.

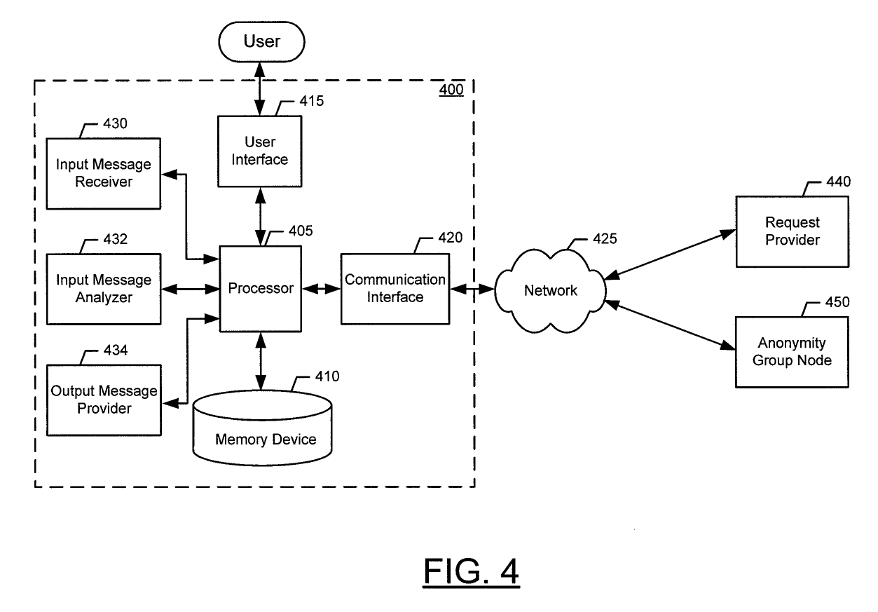

Referring now to FIG. 4, an exemplary apparatus 400 for anonymous polling is described. Apparatus 400 may be embodied as a node, a computer, a server, or other network device such as a user terminal 10 of FIG. 1. The apparatus 400 may include or otherwise be in communication with a processor 405, a user interface 415, a communication interface 420, and a memory device 410. The memory device 410 may include, for example, volatile and/or non-volatile memory (e.g., volatile memory 40 and/or non-volatile memory 42). The memory device 410 may be configured to store information, data, applications, instructions, or the like for enabling the apparatus to carry out various functions in accordance with exemplary embodiments of the present invention. For example, the memory device 410 could be configured to buffer input data for processing by the processor 405. Additionally or alternatively, the memory device 410 could be configured to store instructions for execution by the processor 405. As yet another alternative, the memory device 410 may be one of a plurality of databases that store information in the form of static and/or dynamic information, for example, in association with requests, responses, anonymity group member addresses, or the like.

The processor 405 may be embodied in a number of different ways. For example, the processor 405 may be embodied as one or more microprocessors, coprocessors, controllers (e.g., controller 20 from FIG. 1), or various other processing means or elements including integrated circuits such as, for example, ASICs (application specific integrated circuit) or FPGAs (field programmable gate array). In an exemplary embodiment, the processor 405 may be configured to execute instructions stored in the memory device 410 or otherwise accessible to the processor 405.

The user interface 415 may be in communication with the processor 405 to receive an indication of a user input at the user interface 415 and/or to provide an audible, visual, mechanical, or other output to the user. As such, the user interface 415 may include, for example, a keyboard, a mouse, a joystick, a touch screen display, a conventional display, a microphone, a speaker, or other input/output mechanisms. In an exemplary embodiment in which the apparatus 400 is embodied as a server, the user interface 415 may be limited, or even eliminated.

The communication interface 420 may be embodied as any device or means embodied in either hardware, software, or a combination of hardware and software that is configured to receive and/or transmit data from/to a network and/or any other device or module in communication with the apparatus 400, such as user terminal 10. In this regard, the communication interface 420 may include, for example, an antenna, a transmitter, a receiver, a transceiver and/or supporting hardware or software for enabling communications with network 425, which may be any type of wired or wireless network. While network 425 may utilize a tiered structure, a peer-to-peer structure may also be implemented. Via the communication interface 420 and the network 425, the apparatus 400 may communicate with the request provider 440 and the anonymity group node 450. In some exemplary embodiments, the anonymity group node 450 may include one or more nodes.

The request provider 440 may be any type of computing device for storing, retrieving, computing, transmitting, and receiving data. Request provider 440 may operate in the same manner as described with respect to request provider 300. The request provider 440 may include a memory device, a processor, and a communication interface for communicating with the network 425. In some embodiments, the request provider 440 may be a web server, database server, file server, or the like.

The anonymity group node 450 may also be any type of device for storing, retrieving, computing, transmitting, and receiving data. Anonymity group node 450 may be a member of the same anonymity group as apparatus 400. Anonymity group node 450 may operate in the same manner as described with respect to the nodes (i.e., the first node 310, the second node 320, etc.) of FIG. 3. In some exemplary embodiments, the anonymity group node 450 may be embodied as a user terminal 10 of FIG. 1, a computer that may implement a client web browser application, a computer that may implement a client application, or the like. Anonymity group node 450 may be representative of a plurality of anonymity group nodes, and as such any number of anonymity group nodes may be included in FIG. 4 connected to the network 425. In various embodiments, the anonymity group node 450 may operate with the apparatus 400 to maintain anonymity of a responder.

In some exemplary embodiments, the anonymity group node 450 may be a client web browser application or the client application implemented on a network platform. In this regard, the anonymity group node 450 may be associated with a network platform that a user is currently utilizing to access the network 425 or is otherwise associated with. In this regard, the anonymity group node 450 may be moved from a first network platform to a second network platform based on the platform that is currently being utilized by the user. Further, via network 425, the various network platforms may synchronize data so that a user may access the data from any network platform.

An input message receiver 430, an input message analyzer 432, and an output message provider 434 modules of the apparatus 400 may be any means or device embodied in hardware, software, or a combination of hardware and software that is configured to carry out the functions of the input message receiver 430, the input message analyzer 432, and the output message provider 434, respectively, as described herein, to provide functions on the referral agent node, the responder node, and the forwarding agent node. The modules 430, 432 and 434 may also be embedded in one or more software applications. In an exemplary embodiment, the processor 405 may include, or otherwise control the input message receiver 430, the input message analyzer 432, and the output message provider 434.

The input message receiver 430 may be configured to receive an input message. In this regard, the apparatus 400 may include various means for receiving an input message, which may include the processor 405, the input message receiver 430, the communications interface 420, algorithms for receiving an input message described herein and executed by the foregoing or other elements, and/or the like. According to various exemplary embodiments of the present invention, an input message may include a request or a response to a request. According to exemplary embodiments, the input message may also include a source identifier (e.g., an address). In this regard, the source identifier may indicate a network device or node that provided the input message to the input message receiver 430.

The input message analyzer 432 may be configured to identify whether the input message includes a request or a response to the request. In this regard, the apparatus 400 may include various means for identifying whether the input message includes a request or a response to the request, which may include the processor 405, the input message analyzer 432, algorithms for identifying whether the input message includes a request or a response to the request described herein and executed by the foregoing or other elements, and/or the like. The input message analyzer may interpret the input message in any known manner to determine whether the input message includes a request or a response. One alternative is to check a message request field and/or a message response field whether they are empty or include any content, e.g. character strings or file attachment.

Further, the input message analyzer 432 may be configured to identify a source of the input message. In some exemplary embodiments, if the input message includes a request the source of the input message may be identified. In this regard, the apparatus 400 may include various means for identifying a source of the input message, which may include the processor 405, the input message analyzer 432, algorithms for identifying a source of the input message described herein and executed by the foregoing or other elements, and/or the like. In some exemplary embodiments, the input message analyzer 432 may identify a source of the input message by interpreting portions of fields of the input message that include a source/node identifier. Using the source/node identifier as, for example, a group identification code/name, the input message analyzer 432 may determine whether the source or a node is a member of an anonymity group in common with the apparatus 400. Additionally, the source/node identifier may include role information of the source (i.e. a referral agent, a responder or a forwarding agent). Via the role information the input message analyzer 432 may be configured to identify a role of the apparatus 400.

In some embodiments, the input message analyzer 432 may be further configured to identify whether the apparatus 400 was also a responder to a common request. In this regard, the input message analyzer 432 may interpret the input message to determine if the apparatus 400 had also responded to, or was an intended responder of, a common request. In some exemplary embodiments, the input message may include a request identifier which may be used to determine if a common request had been received by the apparatus 400.

The output message provider 434 may be configured to provide for transmission of an output message. In this regard, the apparatus 400 may include various means for providing for transmission of an output message, which may include the processor 405, the output message provider 434, algorithms for providing for transmission of an output message described herein and executed by the foregoing or other elements, and/or the like.

The output message provider 434 may be configured to provide for transmission of the output message such that the output message includes a request and the output message is transmitted to a member of an anonymity group in common with apparatus 400, such as anonymity group node 450, when the input message includes a request and/or the source of the input message is identified as a request provider, such as request provider 440. In this regard, the apparatus 400 may be operating as a referral agent.

In some exemplary embodiments, when the input message includes a request and the source of the input message is identified as a request provider, the processor 405 may be configured to identify a user selected member of the anonymity group in common with the apparatus 400. In this regard, the selected member of the anonymity group may be selected based on a user preference. Further, in this regard, the output message provider 434 may be configured to provide for transmission of the output message to the user selected member of the anonymity group.

The output message provider 434 may be further configured to provide for transmission of the output message such that the output message includes a response and the output message is transmitted to a member of the anonymity group in common with apparatus 400, such as anonymity group node 450, when the input message includes a request and/or the source of the input message is identified as a member of the anonymity group (e.g., a referral agent) in common with apparatus 400. In this regard, the apparatus 400 may be operating as a responder. In some embodiments, when the input message includes a request and the source of the input message is identified as a member of the anonymity group in common with apparatus 400, the output message may also be encrypted. Further, in some embodiments, the processor 405 may be configured to generate a response to a request.

In some exemplary embodiments, when the input message includes a request and the source of the input message is identified as a member of the anonymity group in common with apparatus 400, such as anonymity group node 450, the processor 405 may be configured to identify a user selected member of the anonymity group in common with the apparatus 400. In this regard, the selected member of the anonymity group may be selected based on a user preference. Further, in this regard, the output message provider 434 may be configured to provide for transmission of the output message to the user selected member of the anonymity group.

The output message provider 434 may be further configured to provide for transmission of the output message such that the output message includes a response, when the input message includes a response and/or the source of the input message is identified as a responder. In this regard, the apparatus 400 may be operating as a forwarding agent. In various embodiments, when the input message includes a response, the output message may be transmitted to a request provider, such as request provider 440. In an additional embodiment, the output message provider 434 may be further configured to remove all information from the output message that could reveal the identity of the responder device or user of the responder device, such as, for example, an IP address, a MAC address, name of the user, contact information of the user, and IMEI (International Mobile Equipment Identity) code, Mobile Electronic Serial Number (MEID), International Mobile Subscriber Identity (IMSI), MSISDN (Mobile Subscriber Integrated Services Digital Network Number), or the like. In an exemplary embodiment that may utilize the exemplary message format of FIG. 6, the output message provider 434 may be configured to remove all portions or fields of information from the message format except the requestor's address, the sender's address, and response content. Additionally, in some exemplary embodiments, the output message provider 434 may also be configured to maintain the portions or fields of the exemplary message format directed to the user group identifier, and the request identifier.

Additionally, or alternatively, in some exemplary embodiments, output message provider 434 may be further configured to provide for transmission of the output message such that the output message includes a response and the output message is transmitted to a member of the anonymity group in common with apparatus 200, such as anonymity group node 450, when the input message includes a response and the input message analyzer 432 determines that the apparatus 400 has been a previous responder to a common request. In this regard, the apparatus 400 may be operating as a previous responder between a responder and a forwarding agent.

In some exemplary embodiments, the request provider 440 may define the anonymity group based on criteria received by the request provider 440. In this regard, in the formulating a request, a target audience may also be identified. Criteria for the target audience may be received by the request provider 440 to either determine the appropriate predefined anonymity group to send the request, or dynamically define the anonymity group based on the criteria for the target audience.

In various embodiments, input messages may be sent to/received by members of a group, such as an anonymity group. The members of the anonymity group may be related based on some common characteristic. For example, the common characteristic may be the type of information that members of the anonymity group have chosen to make available to potential requesters. Alternatively or additionally, a common characteristic may be a same interest group, a same subscribed service (e.g., a music service), participation on the same discussion/social forum, or the like.

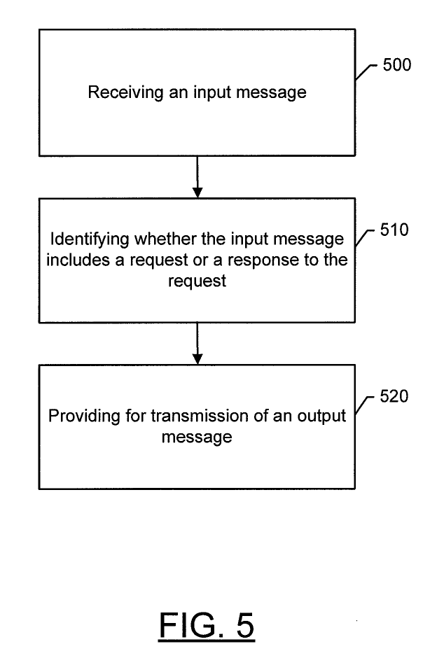

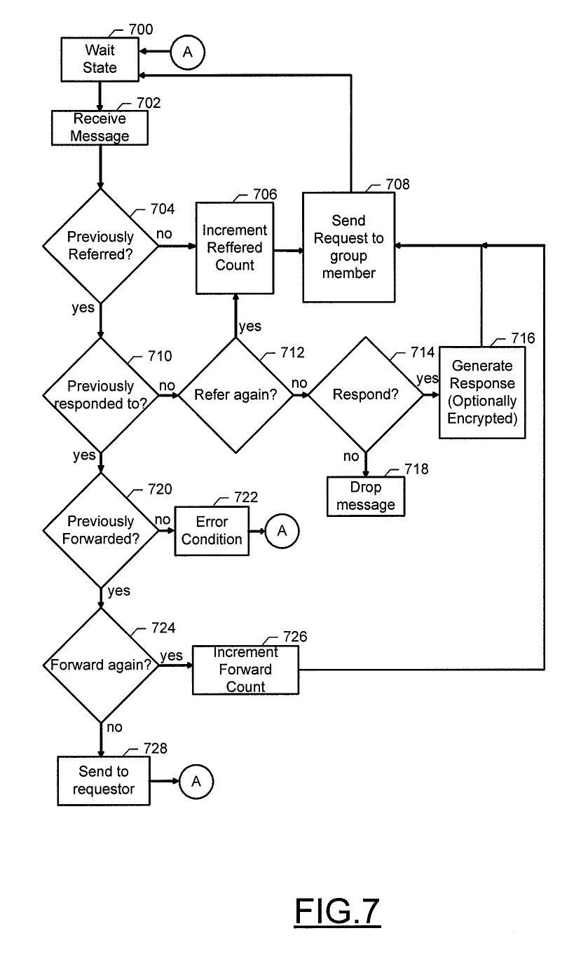

FIGS. 5 and 7 are flowcharts of a system, method, and program product according to exemplary embodiments of the invention. It will be understood that each block, step, or operation of the flowcharts, and combinations of blocks, steps or operations in the flowchart, can be implemented by various means, such as hardware (e.g., controller 10, processor 405, or the like), firmware, and/or software including one or more computer program code portions, program instructions, or executable program code portions. For example, one or more of the procedures described above may be embodied by computer program code instructions. In this regard, the computer program instructions which embody the procedures described above may be stored by a memory device of the apparatus and executed by a processor in the apparatus. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s), step(s), or operation(s). These computer program instructions may also be stored in a computer-readable memory that can direct a computer, a processor, or other programmable apparatus to function in a particular manner, such that the instructions stored in the computer-readable memory produce an article of manufacture including instruction means which implement the function specified in the flowcharts block(s), step(s), or operation(s). The computer program instructions may also be loaded onto a computer, processor, or other programmable apparatus to cause a series of operational steps to be performed on the computer, processor, or other programmable apparatus to produce a computer-implemented process such that the instructions which execute on the computer, processor, or other programmable apparatus provide steps for implementing the functions specified in the flowcharts block(s), step(s), or operation(s).

Accordingly, blocks, steps, or operations of the flowcharts support combinations of means for performing the specified functions, combinations of steps for performing the specified functions and program instruction means for performing the specified functions. It will also be understood that one or more blocks, steps, or operations of the flowcharts, and combinations of blocks, steps, or operations in the flowcharts, can be implemented by special purpose hardware-based computer systems which perform the specified functions or steps, or combinations of special purpose hardware and computer instructions.

In this regard, one exemplary embodiment of a method for anonymous polling as illustrated in FIG. 5 may include receiving an input message at 500. At 510, the exemplary method may include identifying whether the input message includes a request or a response to the request. In this regard, the exemplary method may include identifying a source of the input message if the input message includes the request. Additionally, the method may include identifying a role (i.e., a referral agent, a responder or a forwarding agent) of the source of the input message. As a result, the role of the apparatus 400 (i.e., the receiving node) may be the next logical role. At 520, the exemplary method may include providing for transmission of an output message.

According to the exemplary method, the output message may include the request and the output message may be transmitted to a member of a user group, such as an anonymity group, when the input message includes the request and/or the source of the input message is identified as a request provider. Further, according to the exemplary method, the output message may include the response and the output message may be transmitted to a member of the anonymity group, when the input message includes the request and/or the source of the input message is identified as a member of an anonymity group. Additionally, according the exemplary method, the output message may include the response, when the input message includes the response (e.g., when action is performed by the referral agent).

In some exemplary embodiments, the exemplary method may also include generating the response to the request prior to providing for transmission of the output message. Further, providing for transmission of the output message in the exemplary method may comprise the output message being transmitted to the request provider, when the input message includes the response and/or the source of the input message is identified as a member of an anonymity group (e.g., when the action is performed by a responder). In one embodiment, the output message provider 434 may be further configured to remove all information from the output message that could reveal identity of the responder device or user of the responder device. In some embodiments of the exemplary method, providing for transmission of the output message may comprise the request provider defining the anonymity group based on criteria received by the request provider.

Further, in some embodiments of the exemplary method, providing for transmission of the output message may include members of the anonymity group being related based on a common characteristic, the common characteristic defining the anonymity group. Embodiments of the exemplary method may also include providing for transmission of the output message wherein providing for transmission of the output message comprises the output message being encrypted, when the input message includes the request and the source of the input message is identified as a member of the anonymity group. Further, some embodiments of the exemplary method may include providing for transmission of the output message wherein providing for transmission of the output message may further comprise identifying a user selected member of the anonymity group and providing for transmission of the output message to the user selected member of the anonymity group, when the input message includes the request and the source of the input message is identified as the request provider. In this regard, the user selected member of the anonymity group may be selected based on a user preference. Additionally, or alternatively, some embodiments of the exemplary method may include providing for transmission of the output message wherein providing for transmission of the output message may comprise identifying a user selected member of the anonymity group and providing for transmission of the output message to the user selected member of the anonymity group, when the input message includes the request and the source of the input message is identified as a member of the anonymity group. In this regard, the user selected member of the anonymity group may be selected based on a user preference.

FIG. 7 illustrates flowchart describing another method for anonymous polling according to exemplary embodiments of the present invention, which, in some exemplary embodiments, may be performed by a node of a user group (e.g., apparatus 400). The exemplary method may include a wait state at 700. During the wait state, a node may be awaiting a message. At 702, a message may be received. After receipt of the message, the message may be analyzed to determine how to proceed with respect to the message.

At 704 the message may be analyzed to determine whether the message was previously referred. To determine whether a message was previously referred, a referred count (e.g., referred count 691) may be analyzed. If no referral of the message has occurred (e.g., the referred count equals zero) then referred count may be incremented at 706. The message may then be sent to another group member, which may be randomly selected, at 708. The method may then return to the wait state at 700.

If the message had been previously referred (e.g., the referred count is greater than zero), then an analysis of the message may be undertaken to determine whether the request within the message had been previously responded to by another node. In some embodiments, a response content field may be checked. If content is present in the response content field, then it may be determined that the request has been replied to by another node. If reply of the message has not be responded to by another node (e.g., the response content field is empty), then, at 712 the message may be analyzed to determine whether the message may be referred again. In this regard, the referred count may be compared to a threshold referred count. If the referred count is less than the threshold referred count, then the referred count may be incremented at 706 and the message may be referred again at 708. If the referred count equals or exceeds the threshold referred count, then a determination may be made as to whether a user associated with a node implementing the method desires to respond at 714. If the user does not desire to respond, then the message may be dropped (i.e., no further action need be taken with respect to the message). If the user desires to respond, a response may be generated and a response content field may be populated at 716. In an exemplary embodiment, the generated response may be encrypted and the response content field may be populated with an encrypted response. In some exemplary embodiments, a forwarding flag may be set indicating that a response has been provided, which may be used at 710 to determine whether a massage had been previously responded to. Upon populating the response content field with a response, the message may then be sent to another group member, which may be randomly selected, at 708. The method may then return to the wait state at 700.

If the message had been previously responded to, a determination may be made as to whether the message was previously forwarded at 720. In this regard, in some exemplary embodiments, a forwarded count (e.g., forwarded count 692) may be checked. If the message had not been previously forwarded (e.g., the forwarded count is equal to zero), an error condition may be detected at 722 and the method may return to the wait state 700. If the message had been previously forwarded (e.g., the forwarded count is greater than zero), then a determination as to whether additional forwards may occur may be determined. In this regard, the forwarded count may be compared to a threshold forwarded count. If the forwarded count is less than the threshold forwarded count, then the forwarded count may be incremented at 726 and the message may be forwarded again at 708. If the forwarded count equals or exceeds the threshold forwarded count, then the message may be sent to the requester or other non-group entity at 728.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an input message;
identifying whether the input message includes a request or a response to the request and, if the input message includes the request, further identifying a source of the input message; and
providing for transmission of an output message;
wherein providing for transmission of the output message comprises the output message including the request and the output message being transmitted to a member of an anonymity group, when the input message includes the request and the source of the input message is identified as a request provider;
wherein providing for transmission of the output message comprises the output message including the response and the output message being transmitted to a member of the anonymity group, when the input message includes the request and the source of the input message is identified as a member of the anonymity group; and
wherein providing for transmission of the output message comprises the output message including the response, when the input message includes the response.

2. The method of claim 1, wherein providing for transmission of the output message comprises the output message being transmitted to the request provider, when the input message includes the response.

3. The method of claim 1, wherein providing for transmission of the output message comprises the request provider defining the anonymity group based on criteria received by the request provider.

4. The method of claim 1, wherein providing for transmission of the output message includes members of the anonymity group being related based on a common characteristic, the common characteristic defining the anonymity group.

5. The method of claim 1, wherein providing for transmission of the output message comprises encrypting the output message when the input message includes the request and the source of the input message is identified as a member of the anonymity group.

6. The method of claim 1, wherein providing for transmission of the output message further comprises:
identifying a user selected member of the anonymity group, the user selected member of the anonymity group being selected based on a user preference; and
providing for transmission of the output message to the user selected member of the anonymity group, when the input message includes the request and the source of the input message is identified as the request provider.

7. The method of claim 1, wherein providing for transmission of the output message comprises:
identifying a user selected member of the anonymity group, the user selected member of the anonymity group being selected based on a user preference; and
providing for transmission of the output message to the user selected member of the anonymity group, when the input message includes the request and the source of the input message is identified as a member of the anonymity group.

8. The method of claim 1, further comprising generating the response to the request prior to providing for transmission of the output message.

9. An apparatus comprising a processor, the processor configured to:
receive an input message;
identify whether the input message includes a request or a response to the request and, if the input message includes the request, the processor may be further configured to identify a source of the input message; and
provide for transmission of an output message;
wherein the processor being configured to provide for transmission of the output message includes being configured to provide for transmission of the output message, the output message including the request and the output message being transmitted to a member of an anonymity group, when the input message includes the request and the source of the input message is identified as a request provider;
wherein the processor being configured to provide for transmission of the output message includes being configured to provide for transmission of the output message, the output message including the response and the output message being transmitted to a member of the anonymity group, when the input message includes the request and the source of the input message is identified as a member of the anonymity group; and
wherein the processor being configured to provide for transmission of the output message includes being configured to provide for transmission of the output message, the output message including the response, when the input message includes the response.

10. The apparatus of claim 9, wherein the processor being configured to provide for transmission of the output message includes being configured to provide for transmission of the output message to the request provider, when the input message includes the response.

11. The apparatus of claim 9, wherein the processor being configured to provide for transmission of the output message includes being configured to provide for transmission of the output message, wherein the request provider defines the anonymity group based on criteria received by the request provider.

12. The apparatus of claim 9, wherein the processor being configured to provide for transmission of the output message includes being configured to provide for transmission of the output message, wherein the members of the anonymity group are related based on a common characteristic, the common characteristic defining the anonymity group.

13. The apparatus of claim 9, wherein the processor being configured to provide for transmission of the output message includes being configured to encrypt the output message when the input message includes the request and the source of the input message is identified as a member of the anonymity group.

14. The apparatus of claim 9, wherein the processor being configured to provide for transmission of the output message includes being configured to:
identify a user selected member of the anonymity group, the user selected member of the anonymity group being selected based on a user preference; and
provide for transmission of the output message to the user selected member of the anonymity group, when the input message includes the request and the source of the input message is identified as the request provider.

15. The apparatus of claim 9, wherein the processor being configured to provide for transmission of the output message includes being configured to:
identify a user selected member of the anonymity group, the user selected member of the anonymity group being selected based on a user preference; and
provide for transmission of the output message to the user selected member of the anonymity group, when the input message includes the request and the source of the input message is identified as a member of the anonymity group.

16. The apparatus of claim 9, wherein the processor is further configured to generate the response to the request.

17. A computer program product comprising at least one computer-readable storage medium having executable computer-readable program code portions stored therein, the computer-readable program code portions comprising:
a first program code portion configured to receive an input message;
a second program code portion configured to identify whether the input message includes a request or a response to the request and, if the input message includes the request, the second program code portion may be configured to also identify a source of the input message; and
a third program code portion configured to provide for transmission of an output message;
wherein the third program code portion being configured to provide for transmission of the output message includes being configured to provide for transmission of the output message, the output message including the request and the output message being transmitted to a member of an anonymity group, when the input message includes the request and the source of the input message is identified as a request provider;
wherein the third program code portion being configured to provide for transmission of the output message includes being configured to provide for transmission of the output message, the output message including the response and the output message being transmitted to a member of the anonymity group, when the input message includes the request and the source of the input message is identified as a member of the anonymity group; and
wherein the third program code portion being configured to provide for transmission of the output message includes being configured to provide for transmission of the output message, the output message including the response, when the input message includes the response.

18. The computer program product of claim 17, wherein the third program code portion being configured to provide for transmission of the output message includes being configured to provide for transmission of the output message to the request provider, when the input message includes the response.

19. The computer program product of claim 17, wherein the third program code portion being configured to provide for transmission of the output message includes being configured to provide for transmission of the output message, wherein the request provider defines the anonymity group based on criteria received by the request provider.

20. The computer program product of claim 17, wherein the third program code portion being configured to provide for transmission of the output message includes being configured to provide for transmission of the output message, wherein the members of the anonymity group are related based on a common characteristic, the common characteristic defining the anonymity group.

21. The computer program product of claim 17, wherein the third program code portion being configured to provide for transmission of the output message includes being configured to encrypt the output message when the input message includes the request and the source of the input message is identified as a member of the anonymity group.

22. The computer program product of claim 17, wherein the third program code portion being configured to provide for transmission of the output message includes being configured to:
identify a user selected member of the anonymity group, the user selected member of the anonymity group being selected based on a user preference; and
provide for transmission of the output message to the user selected member of the anonymity group, when the input message includes the request and the source of the input message is identified as the request provider.

23. The computer program product of claim 17, wherein the third program code portion being configured to provide for transmission of the output message includes being configured to:
identify a user selected member of the anonymity group, the user selected member of the anonymity group being selected based on a user preference; and
provide for transmission of the output message to the user selected member of the anonymity group, when the input message includes the request and the source of the input message is identified as a member of the anonymity group.

24. The computer program product of claim 17, wherein the computer-readable program code portions further comprise a fourth program code portion configured to generate the response to the request prior to providing for transmission of the output message.

25. An apparatus comprising:
means for receiving an input message;
means for identifying whether the input message includes a request or a response to the request and, if the input message includes the request, further identifying a source of the input message; and
means for providing for transmission of an output message;
wherein means for providing for transmission of the output message comprises the output message including the request and the output message being transmitted to a member of an anonymity group, when the input message includes the request and the source of the input message is identified as a request provider;
wherein means for providing for transmission of the output message comprises the output message including the response and the output message being transmitted to a member of the anonymity group, when the input message includes the request and the source of the input message is identified as a member of the anonymity group; and
wherein means for providing for transmission of the output message comprises the output message including the response, when the input message includes the response.

26. The apparatus of claim 25, wherein means for providing for transmission of the output message comprises includes members of the anonymity group being related based on a common characteristic, the characteristic defining the anonymity group.

27. The apparatus of claim 25 further comprising means for generating the response to the request.
